(19) United States
(12) Patent Application Publication
(10) Pub. No.: US 2026/0178007 A1
(43) Pub. Date: Jun. 25, 2026

(54) SERVO ADJUSTMENT SYSTEM

(71) Applicant: FANUC CORPORATION, Minamitsuru-gun, Yamanashi (JP)

(72) Inventor: Makoto SUZUKI, Yamanashi (JP)

(73) Assignee: FANUC CORPORATION, Minamitsuru-gun, Yamanashi (JP)

(21) Appl. No.: 18/854,495

(22) PCT Filed: Apr. 25, 2022
(86) PCT No.: PCT/JP2022/018671

§ 371 Date: Oct. 4, 2024

(51) Int. Cl. G05B 19/409; G05B 13/02; G05B 13/04; G05B 19/19; G05B 19/404

(52) U.S. Cl. CPC G05B 19/409; G05B 13/024; G05B 13/0265; G05B 13/042; G05B 19/19; G05B 19/404

(57) ABSTRACT

Provided is a servo adjustment apparatus that is capable of performing automatic servo adjustment with high accuracy and in a short time, without the need for an additional device. A servo adjustment system 1 that adjusts control parameter setting information of a servomotor controlled by a control apparatus of an industrial machine comprises: a servomotor model 30 which is a virtualization of the operation of the servomotor; a virtual control apparatus 20 that executes an evaluation program on the basis of the control parameter setting information to virtually control the servomotor model 30; and a servo adjustment apparatus 10 that determines the control parameter setting information on the basis of virtual feedback information, which is obtained by executing the evaluation program a plurality of times in the virtual control device 20 on the basis of different control parameter setting information.

### TECHNICAL FIELD

The present disclosure relates to a servo adjustment system.

### BACKGROUND ART

Conventionally, control parameter adjustment (hereinafter referred to as servo adjustment) techniques of servo motors have been known such as gain filter adjustment, feedforward adjustment, and acceleration/deceleration adjustment. In these servo adjustment techniques, an improvement in the adjustment accuracy and shortening of the adjustment time have been demanded.

However, in order to perform servo adjustment, feedback information for when a servo motor or a machine tool that is the control target is actually operated is required. Therefore, during the execution of servo adjustment, the control target cannot be used for other purposes. In addition, the time for actually operating the control target and acquiring the feedback information cannot be shortened.

On the other hand, a technique for performing servo adjustment so that the movement of a tool tip point matches the command has been proposed (for example, refer to Patent Document 1). In addition, a technique for assisting servo adjustment using a virtual model has been proposed (for example, refer to Patent Document 2).

### CITATION LIST

### Patent Document

Patent Document 1: Japanese Unexamined Patent Application, Publication No. 2006-172149
Patent Document 2: Japanese Unexamined Patent Application, Publication No. 2017-167607

### DISCLOSURE OF THE INVENTION

### Problems to be Solved by the Invention

However, the technology of Patent Document 1 requires an additional device such as an acceleration sensor, which increases the cost. In addition, the technology of Patent Document 2 requires the user to determine a parameter value, which increases the workload and causes operation error.

The present disclosure has been made taking account of the above situation, and has an object of providing a servo adjustment device capable of automatically performing servo adjustment with high accuracy and in a short time without requiring additional devices.

### Means for Solving the Problems

An aspect of the present disclosure relates to a servo adjustment system for adjusting control parameter setting information of a servo motor controlled by a control device of an industrial machine, the servo adjustment system including: a servo motor model in which operation of the servo motor is virtualized; a virtual control device which virtually controls the servo motor model by executing an evaluation program based on the control parameter setting information; and a servo adjustment device which determines the control parameter setting information, based on virtual feedback information obtained by executing the evaluation program a plurality of times based on different pieces of the control parameter setting information in the virtual control device.

### Effects of the Invention

According to the present disclosure, it is possible to provide a servo adjustment device capable of automatically performing servo adjustment with high accuracy and in a short time without requiring additional devices.

### BRIEF DESCRIPTION OF THE DRAWINGS

FIG. 1 is a block diagram illustrating a configuration of a servo adjustment system according to a first embodiment;

FIG. 2 is a flowchart showing a sequence of servo adjustment processing executed by the servo adjustment system according to the first embodiment;

FIG. 3 is a flowchart illustrating a sequence of feedback information generation processing;

FIG. 4 is a diagram showing servo parameter information;

FIG. 5 is a diagram showing servo motor model information;

FIG. 6 is a diagram showing control target model information;

FIG. 7 is a diagram showing command information;

FIG. 8 is a diagram showing servo motor model operation information established by considering a motor friction coefficient;

FIG. 9 is a diagram showing servo motor model operation information established by considering a motor friction coefficient and a feed shaft friction coefficient.

FIG. 10 is a flowchart illustrating a sequence of parameter setting determination processing;

FIG. 11 is a diagram illustrating an example of parameter adjustment;

FIG. 12 is a block diagram illustrating a configuration of a servo adjustment system according to a second embodiment;

FIG. 13 is a block diagram illustrating a configuration of a servo adjustment system according to a modification of the second embodiment;

FIG. 14 is a flowchart showing a sequence of servo adjustment processing executed by the servo adjustment system according to the second embodiment;

FIG. 15 is a flowchart showing a sequence of tentative determination processing of parameter setting;

FIG. 16 is a diagram illustrating an example of a parameter setting pattern;

FIG. 17 is a diagram illustrating an example of parameter settings applied to a plurality of virtual environments;

FIG. 18 is a flowchart illustrating a sequence of parameter setting determination processing; and

FIG. 19 is a diagram illustrating an example of learning results.

### PREFERRED MODE FOR CARRYING OUT THE INVENTION

Hereinafter, embodiments of the present disclosure will be described in detail with reference to the drawings. It should be noted that, in the descriptions of the second embodiment and the third embodiment, components common to those of the first embodiment are denoted by the same reference numerals, and the descriptions thereof are omitted as appropriate.

### First Embodiment

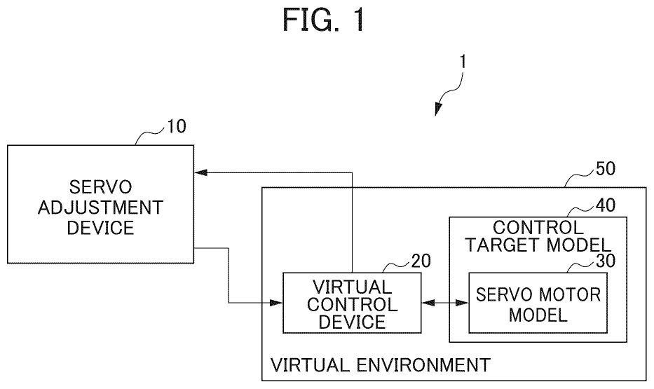

A servo adjustment system 1 according to a first embodiment is a system that adjusts control parameter setting information (hereinafter referred to as parameter setting information) of a servo motor controlled by a control device of an industrial machine such as a machine tool, for example. FIG. 1 is a block diagram illustrating a configuration of a servo adjustment system 1 according to a first embodiment. As illustrated in FIG. 1, the servo adjustment system 1 according to the first embodiment includes a servo adjustment device 10, a virtual control device 20, a servo motor model 30, and a control target model 40. The virtual control device 20, the servo motor model 30, and the control target model 40 configure a virtual environment 50.

Each of the servo adjustment device 10 and the virtual control device 20 is a computer configured by hardware such as an arithmetic processing unit such as a CPU (Central Processing Unit), an auxiliary storage unit such as an HDD (Hard Disk Drive) and/or an SSD (Solid State Drive) storing various computer programs, a main storage unit such as RAM (Random Access Memory) for temporarily storing data necessary for the arithmetic processing unit to execute a computer program, an operation unit such as a keyboard on which an operator performs various operations, and a display unit such as a display for displaying various information to the operator. The servo adjustment device 10, the virtual control device 20, and the like can transmit and receive various signals to and from each other, and the communication method thereof is not particularly limited.

The servo adjustment device 10 and/or the virtual control device 20 are communicably connected to a numerical control device (CNC: Computerized Numerical Control) (not shown) corresponding to a control device of an industrial machine such as a machine tool, for example. The servo parameter information, etc. necessary for servo adjustment of the present embodiment described later are part of the CNC parameters stored in the numerical control device, and are acquired from the numerical control device. In addition, the parameter setting information after servo adjustment of the present embodiment is transmitted to the numerical control device, and used for the control of an actual machine.

The servo adjustment device 10 performs control parameter adjustment (hereinafter referred to as servo adjustment) of the servo motor such as gain filter adjustment, feedforward adjustment, and acceleration/deceleration adjustment, for example. More specifically, the servo adjustment device 10 performs servo adjustment by acquiring virtual feedback information (hereinafter referred to as virtual FB information) obtained by executing an evaluation program a plurality of times on the basis of different parameter setting information in the virtual control device 20 described later, and determining parameter setting information on the basis of the acquired virtual feedback information. The adjusted parameter setting information is transmitted to the virtual control device 20 and/or the numerical control device.

Therefore, the servo adjustment device 10 includes a virtual feedback information acquisition unit (not shown) that acquires virtual FB information transmitted from the virtual control device 20, a parameter setting determination unit (not shown) that determines parameter setting information based on a plurality of pieces of virtual FB information obtained by executing with different parameter setting information, and a parameter setting transmission unit (not shown) that transmits the determined parameter setting information to the virtual control device 20 and/or the numerical control device.

The virtual control device 20 virtually controls the servo motor model 30 by executing the evaluation program a plurality of times based on different parameter setting information and generating command information to be passed to the servo motor model 30 described later. In addition, the virtual control device 20 virtually drives a control target model 40 of a machine tool or the like to be described later. The virtual control device 20 transmits feedback information (hereinafter also referred to as FB information.) obtained by virtually controlling the servo motor model 30 and the control target model 40 to the servo adjustment device 10. The current parameter setting information transmitted from the servo adjustment device 10 is applied to the virtual control device 20.

Herein, the evaluation program is a program created so that servo adjustment can be efficiently executed in a short time, separately from an actual machining program which generally has a long machining time. More specifically, the evaluation program is a program that designates a moving distance in the axial direction, a feed speed, and the like according to various machining shapes such as a circle, a square, and a square with corners. However, instead of the evaluation program, an actual machining program which is used by the user in machining can also be used as the evaluation program.

The servo motor model 30 is a model in which the operation and characteristics of the servo motor are virtualized. That is, the virtual environment 50 of the present embodiment includes a servo motor model 30 that virtualizes the operation of a servo motor of a machine tool or the like. More specifically, the servo motor model 30 is a model virtualized by taking account of at least one of the non-damped natural angular frequency, the damping coefficient, the preceding command time, the motor inertia, and the motor friction coefficient. As a result, an operation simulation similar to that of an actual machine becomes possible in the virtual environment 50, and virtual feedback information (hereinafter also referred to as virtual FB information) similar to a case of operating an actual machine can be obtained.

The control target model 40 is a model virtualizing the operation and characteristics of an industrial machine such as a machine tool, for example. That is, the virtual environment 50 of the present embodiment includes the control target model 40 virtualizing an industrial machine such as a machine tool. More specifically, the control target model 40 is a model virtualized by taking account of at least one of the spring constant, the feed axis inertia, the feed axis friction coefficient, and the disturbance torque. As a result, an operation simulation more similar to an actual machine becomes possible in the virtual environment 50, and virtual FB information more similar to that obtained when the actual device is operated can be obtained.

As described above, in the present embodiment, since the generation of the command information to the servo motor model 30 in the virtual control device 20 and the generation of the virtual FB information in the servo motor model 30 and the control target model 40 do not require real time, high speed execution of the servo adjustment becomes possible.

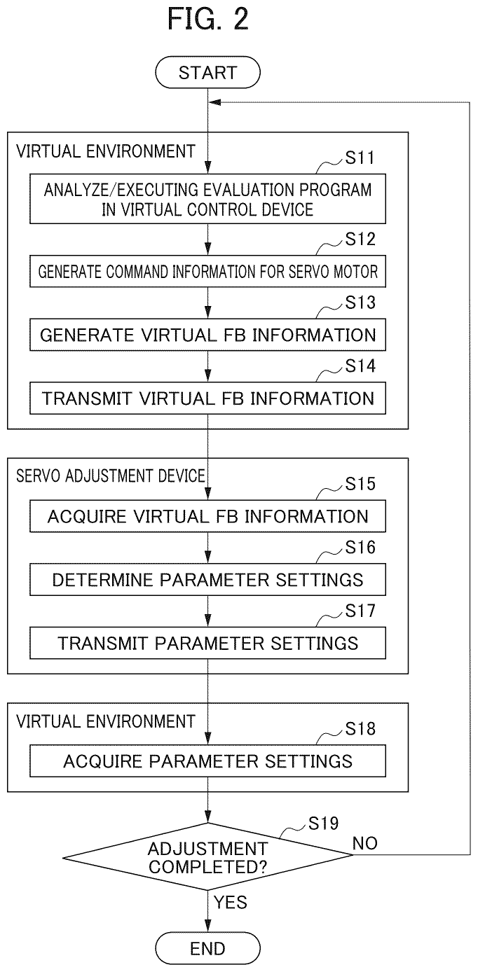

Next, a sequence of servo adjustment processing executed by the servo adjustment system 1 according to the present embodiment will be described in detail with reference to FIG. 2. FIG. 2 is a flowchart showing a sequence of servo adjustment processing executed by the servo adjustment system 1 according to the first embodiment. The servo adjustment processing is started in response to, for example, an input operation from the user to the servo adjustment device 10.

In Step S11, the virtual control device 20 analyzes and executes the evaluation program. More specifically, the virtual control device 20 executes the evaluation program based on the parameter setting information (hereinafter also simply referred to as parameter setting) of the servo motor currently applied to the virtual control device 20. Thereafter, the processing advances to Step S12. It should be noted that this parameter setting is adjusted and changed by servo adjustment processing according to the present flow.

In Step S12, the virtual control device 20 generates command information for the servo motor. More specifically, in Step S11 described above, the virtual control device 20 analyzes and executes the evaluation program, whereby command information for the servo motor is generated. Thereafter, the processing advances to Step S13.

In Step S13, the virtual control device 20 generates virtual FB information. More specifically, the virtual control device 20 generates the virtual FB information by virtually controlling and operating the servo motor model 30 and the control target model 40 based on the command information for the servo motor generated in Step S12. Thereafter, the processing advances to Step S14. The virtual FB information generation processing will be described later in detail.

In Step S14, the virtual control device 20 transmits the virtual FB information generated in Step S13 to the servo adjustment device 10. Thereafter, the processing advances to Step S15.

In Step S15, the servo adjustment device 10 acquires the virtual FB information transmitted from the virtual control device 20. Thereafter, the processing advances to Step S16.

In Step S16, the servo adjustment device 10 determines the parameter setting based on the acquired virtual FB information. Thereafter, the processing advances to Step S17. It should be noted that the parameter setting determination processing will be described in detail later.

In Step S17, the servo adjustment device 10 transmits the parameter setting determined in the aforementioned Step S16 to the virtual control device 20. Thereafter, the processing advances to Step S18.

In Step S18, the virtual control device 20 acquires the parameter setting transmitted from the servo adjustment device 10. The parameter setting newly acquired this time is stored in the virtual control device 20, and applied to the next servo adjustment process. Thereafter, the processing advances to Step S19.

In Step S19, the servo adjustment device 10 determines whether the servo adjustment has completed. More specifically, for example, the servo adjustment device 10 maintains a list of adjustment parameters, and determines whether or not servo adjustment has completed based on whether or not the adjustment of all parameters in the list has completed. In addition, in the adjustment of each parameter, it is determined that the adjustment has not completed until the determination of the parameter setting based on the different virtual FB information is performed at least two times or more, that is, a plurality of times, and it is determined that the adjustment has completed when the adjustment amount of the parameter becomes 1% or less, for example, as described later. However, whether or not the servo adjustment has completed may be determined based on a judgment by the user. If this determination is NO, the processing returns to Step S11, and if YES, the present processing is ended.

According to the servo adjustment processing described above, the parameter setting information is determined and adjusted based on the virtual FB information obtained by analyzing and executing the evaluation program a plurality of times based on the different parameter setting information in the virtual control device 20.

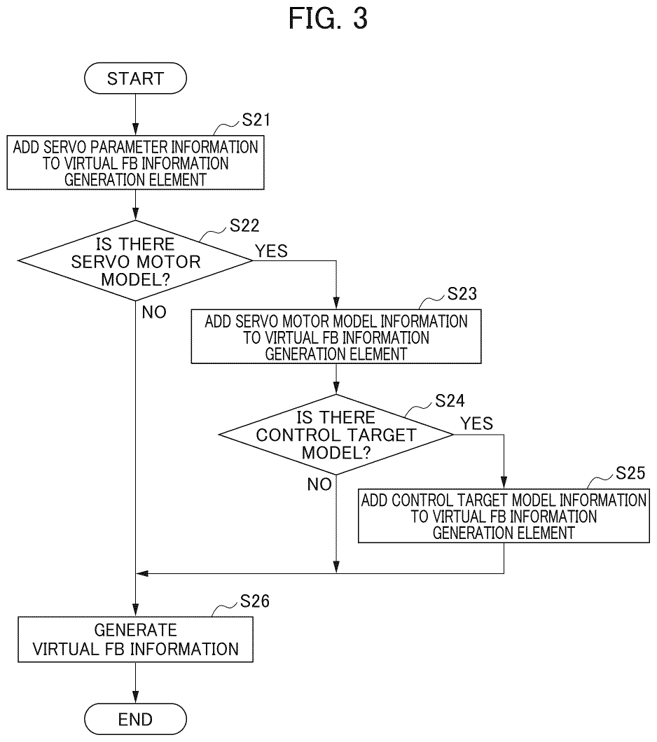

Next, the virtual FB information generation processing in Step S13 of FIG. 2 will be described in detail with reference to FIGS. 3 to 6. Herein, FIG. 3 is a flowchart showing a sequence of the virtual FB information generation processing.

In Step S21, the virtual control device 20 adds servo parameter information to the virtual FB information generation element. That is, the servo parameter information is added to the virtual FB information generation element regardless of the presence or absence of the servo motor model 30 or the control target model 40. Thereafter, the processing advances to Step S22.

Herein, the virtual FB information generation element is information necessary for generating virtual FB information in the virtual environment 50. The servo parameter information added as the virtual FB information generation element serves as a base of the virtual FB information generation element. This servo parameter information is included in the CNC parameters stored in a numerical control device (CNC) (not shown) communicably connected to the servo adjustment system 1 of the present embodiment, and is transmitted from the numerical control device and stored in the virtual control device 20.

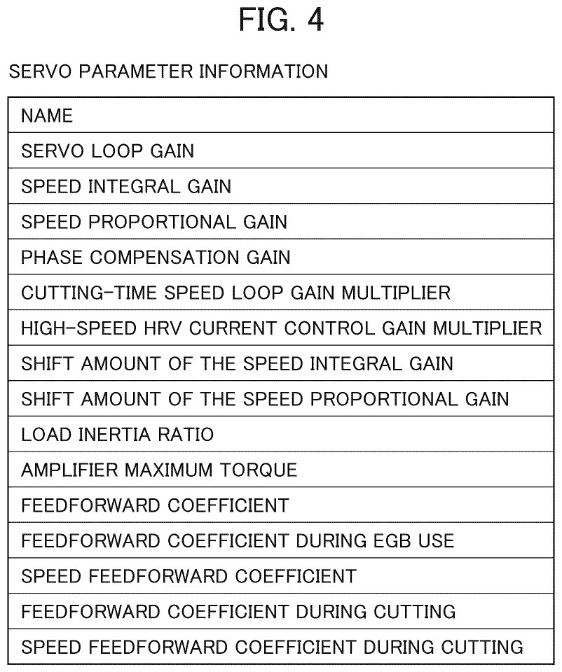

FIG. 4 is a diagram showing servo parameter information. As shown in FIG. 4, the servo parameter information includes, for example, a servo loop gain, a speed integral gain, a speed proportional gain, a phase compensation gain, a cutting-time speed loop gain multiplier, a high-speed HRV (High Response Vector) current control gain multiplier, a shift amount of the speed integral gain, a shift amount of the speed proportional gain, a load inertia ratio, an amplifier maximum torque, a feedforward coefficient, and a feedforward coefficient during electronic gear box (EGB) use, a speed feedforward coefficient, a feedforward coefficient during cutting, and a speed feedforward coefficient during cutting.

Referring back to FIG. 3, in Step S22, the virtual control device 20 determines the presence or absence of the servo motor model 30 in the virtual environment 50. In the servo adjustment system 1 of the present embodiment, since the virtual environment 50 includes the servo motor model 30, this determination is YES, and the processing advances to Step S23. On the other hand, when establishing a configuration which does not provide the servo motor model 30, the determination is NO and the processing advances to Step S26, where the virtual control device 20 generates virtual FB information based on the virtual FB information generation element including the servo parameter information, and then the processing is ended.

In Step S23, the virtual control device 20 adds servo motor model information to the virtual FB information generation element. The virtual FB information generation element thereby comes to include servo parameter information and servo motor model information. Thereafter, the processing advances to Step S24.

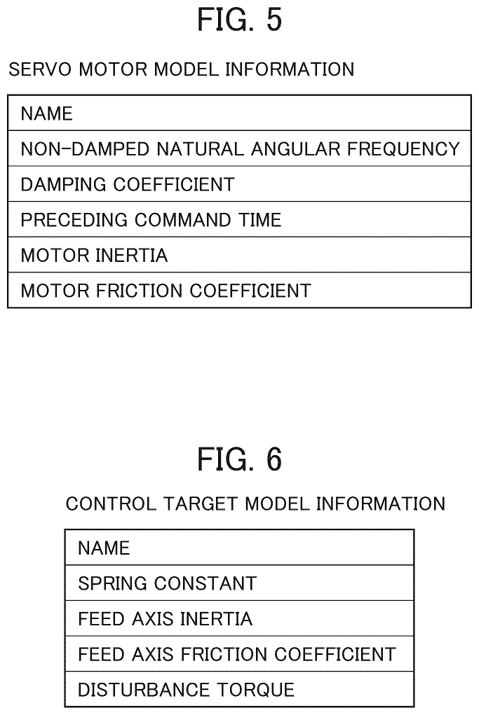

Here, unlike the servo parameter information described above, the servo motor model information is not included in the CNC parameters, but rather is information that is registered by a separate file input, input from a screen operation by a user, or the like, and stored in the virtual control device 20. FIG. 5 is a diagram showing servo motor model information. As shown in FIG. 5, examples of the servo motor model information include a non-damped natural angular frequency, a damping coefficient, a preceding command time, a motor inertia, and a motor friction coefficient.

Referring back to FIG. 3, in Step S24, the virtual control device 20 determines the presence or absence of the control target model 40 in the virtual environment 50. In the servo adjustment system 1 of the present embodiment, since the virtual environment 50 includes the control target model 40, this determination is YES, and the processing advances to Step S25. On the other hand, when the control target model 40 is not provided, the determination becomes NO, and the processing advances to Step S26, where the virtual control device 20 generates virtual FB information based on the virtual FB information generation element including the servo parameter information and the servo motor model information, and then the processing is ended. In this case, since the virtual FB information is generated based on the virtual FB information generation element including the servo motor model information, it is possible to generate virtual FB information more similar to a case of operating an actual machine.

In Step S25, the virtual control device 20 adds the control target model information to the virtual FB information generation element. As a result, the virtual FB information generation element includes servo parameter information, servo motor model information, and control target model information.

Herein, similarly to the servo motor model information described above, the control target model information is not included in the CNC parameters, and is information that is registered by a separate file input, input from a screen operation or the like by a user, and stored in the virtual control device 20. FIG. 6 is a diagram illustrating control target model information. As shown in FIG. 6, examples of the control target model information include a spring constant, feed axis inertia, a feed axis friction coefficient, and a disturbance torque.

Referring back to FIG. 3, after the processing of Step S25 is executed, the processing advances to Step S26, where the virtual control device 20 generates virtual FB information based on the virtual FB information generation element including the servo parameter information, the servo motor model information, and the control target model information, and then the processing is ended. In this case, since the virtual FB information is generated based on the virtual FB information generation element including the servo motor model information and the control target model information, it is possible to generate virtual FB information which is more similar to the virtual FB information in the case of operating an actual machine.

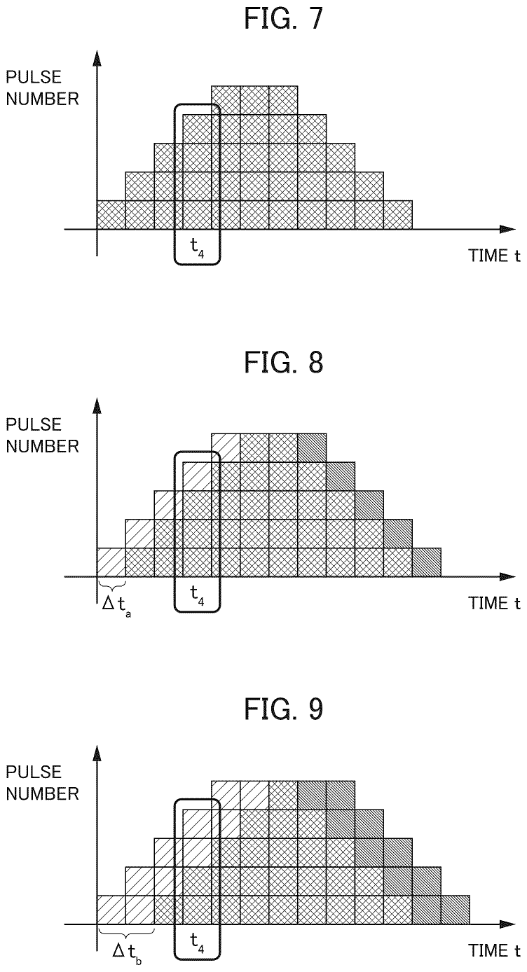

In relation to the virtual FB information generation processing of the present embodiment described above, an example in which the virtual control device 20 generates the virtual FB information by calculating an error amount which is a difference (a pulse number difference or a time difference) between the command information and the servo motor model operation information will be described in detail with reference to FIGS. 7 to 9. FIG. 7 is a diagram showing command information. FIG. 8 is a diagram showing servo motor model operation information prepared by considering a motor friction coefficient. FIG. 9 is a diagram showing servo motor model operation information prepared by considering a motor friction coefficient and a feed shaft friction coefficient. It should be noted that, in FIGS. 8 and 9, among the hatched regions differing from the hatched regions of the pulses of the command information in FIG. 7, the light hatched region represents a region in which the number of pulses is decreased from the number of pulses of the command information, and the dark hatched region represents a region in which the number of pulses is increased from the number of pulses of the command information.

As shown in FIG. 8, it is evident that the pulse of the servo motor model operation information prepared considering the motor friction coefficient included in the servo motor model information is delayed by the time Ata from the pulse of the command information shown in FIG. 7. This is because, when the motor friction coefficient of the servo motor model 30 is taken into consideration, a shift Δtₐ in the delay time occurs until the servo motor model 30 actually rotates/stops with respect to the command information.

Furthermore, as shown in FIG. 9, it is evident that the pulse of the servo motor model operation information prepared considering the feed shaft friction coefficient included in the control target model information in addition to the motor friction coefficient included in the servo motor model information is further delayed by a time Δt_{b}, which is larger than the time Ata, from the pulse of the command information shown in FIG. 7. This is because, when the motor friction coefficient of the servo motor model 30 and the feed shaft friction coefficient of the control target model 40 are taken into consideration, a lag Δt_{b} of the delay time occurs until the servo motor model 30 actually rotates/stops with respect to the command information.

Therefore, for example, when focusing on the time t₄, while the number of pulses of the command information is 4, the number of pulses of the servo motor model operation information prepared considering the motor friction coefficient of the servo motor model 30 is 3, and thus an error amount 1, which is the difference between the two, can be calculated. Similarly, the number of pulses of the servo motor model operation information prepared considering the motor friction coefficient of the servo motor model 30 and the feed shaft friction coefficient of the control target model 40 is 2, and thus an error amount 2, which is the difference between the servo motor model operation information and the command information, can be calculated. In this way, it is possible to calculate the error amount that is the difference from the command information, and it is possible to generate the virtual FB information based on the calculated error amount.

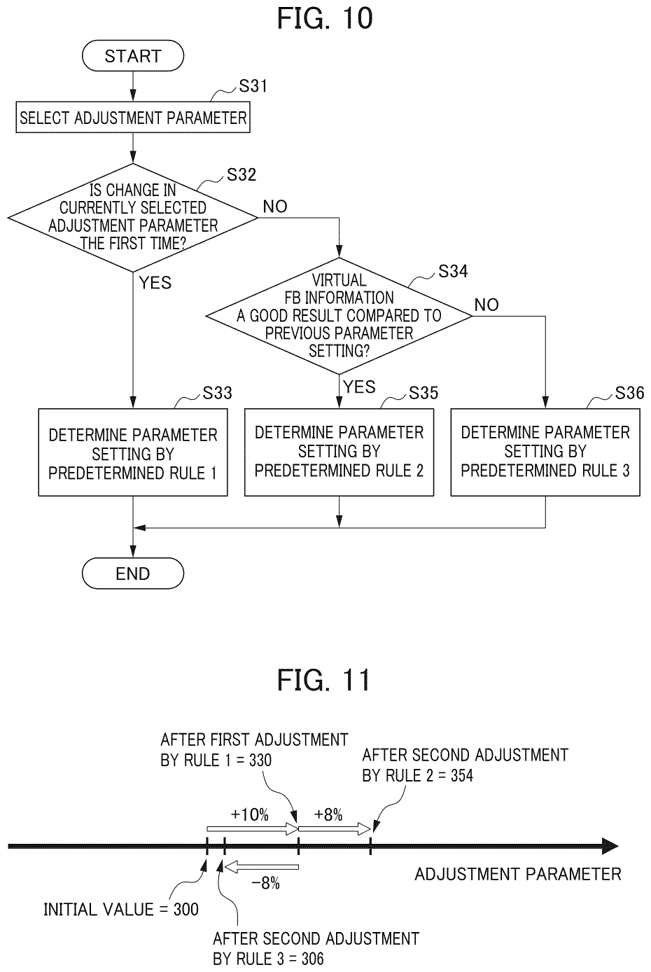

Next, the parameter setting determination processing in Step S16 of FIG. 2 will be described in detail with reference to FIGS. 10 and 11. Herein, FIG. 10 is a flowchart illustrating a sequence of the parameter setting determination processing.

In Step S31, the servo adjustment device 10 selects a parameter (hereinafter referred to as an adjustment parameter), which is the target of servo adjustment. The servo adjustment device 10 stores a list of adjustment parameters in advance, and automatically selects an adjustment parameter from the stored list. Alternatively, the adjustment parameters may be selected according to input information from the user. Thereafter, the processing advances to Step S32.

Herein, the adjustment parameter indicates a parameter which is the target for changing the setting value from the parameter setting determined by acquiring the virtual FB information in the previous servo adjustment processing. In the present embodiment, only one parameter is adjusted at the same time. However, the present invention is not limited thereto, and a plurality of parameters can be adjusted at the same time.

When the adjustment parameter is selected once, the state as selected is normally maintained until the servo adjustment device 10 determines that the adjustment has completed in accordance with a predetermined rule, for example, a rule for continuing the adjustment until the adjustment amount of the adjustment parameter becomes 1% or less. That is, the parameter setting determination processing is repeatedly executed, for example, until the adjustment amount of the adjustment parameter becomes 1% or less. However, it is also possible to configure so as to forcibly interrupt the adjustment according to the input information from the user, and select the next adjustment parameter.

In Step S32, the servo adjustment device 10 determines whether the change in the adjustment parameter selected this time is the first time. More specifically, the servo adjustment device 10 stores the number of times for which the parameter setting determination processing has been executed for each adjustment parameter, and determines whether or not the determination processing of parameter setting for the adjustment parameter selected in Step S31 is the first time, based on the stored information. If this determination is YES, the processing advances to Step S33, and if NO, the processing advances to Step S34.

In Step S33, since the change in the currently selected adjustment parameter is the first time, the parameter setting is determined in accordance with a predetermined rule 1, for example, rule 1 for changing the adjustment parameter so as to be +10% of the initial value. Thereafter, the present processing is ended.

In Step S34, since the change in the adjustment parameter selected this time is not the first time, the servo adjustment device 10 determines whether or not the current virtual FB information generated and acquired by the virtual control device 20 is a better result than the previous parameter setting. For example, in the present embodiment, when the error amount, which is the difference of the virtual FB information relative to the command information, is smaller than that at the time of the previous parameter setting, it is determined that the result is good, and in the converse case of being larger, it is determined that the result is bad. If this determination is YES, the processing advances to Step S35, and if NO, the processing advances to Step S36.

In Step S35, since the current virtual FB information has a better result than the previous parameter setting, the parameter setting is determined according to a predetermined rule 2, for example, rule 2 in which a value corresponding to 80% of the previous adjustment amount is added to the previous value in the same direction as the previous parameter setting (if the second time, since 80% is added to the +10% of the initial value, it will be +8% addition). Thereafter, the present processing is ended.

In Step S36, since the current virtual FB information is a bad result compared with the previous parameter setting, the parameter setting is determined according to a predetermined rule 3, for example, rule 3 in which a value of 80% of the previous adjustment amount is subtracted from the previous value in the direction opposite to the previous parameter setting (if the second time, since 80% is subtracted from +10% of the initial value, it will be −8% subtraction). Thereafter, the present processing is ended.

FIG. 11 is a diagram illustrating an example of the parameter adjustment described above. As shown in FIG. 11, the initial value of the selected adjustment parameter is, for example, 300. In the case of the change in the adjustment parameter being the first time, for example, if adjusting so as to be +10% of the initial value according to the rule 1, the adjusted value becomes 330. Next, in the case of the changing in the adjustment parameter not being the first time, but rather being for the second time, for example, and a case of the current virtual FB information being a better result than that at the time of the previous parameter setting, if the value of 80% of the previous adjustment amount is added to the previous value to adjust in the same direction as at the time of the previous parameter setting according to the rule 2, the adjusted value becomes 354. In addition, in a case where the change of the adjustment parameter is not the first time but rather, for example, the second time, and the current virtual FB information is a bad result as compared with the previous parameter setting time, when the value of 80% of the previous adjustment amount is subtracted from the previous value to adjust in the direction opposite to the previous parameter setting time according to the rule 3, the adjusted value becomes 306. In this way, for example, the determination processing of the parameter setting is repeatedly executed until the adjustment amount of the adjustment parameter becomes 1% or less.

According to the servo adjustment system 1 of the present embodiment, the following effects are exerted.

The servo adjustment system 1 according to the present embodiment is configured to include: a servo motor model 30 virtualizing operation of a servo motor; a virtual control device 20 that virtually controls the servo motor model 30 by executing an evaluation program based on control parameter setting information; and a servo adjustment device 10 that determines control parameter setting information based on the virtual FB information obtained by the virtual control device 20 executing the evaluation program a plurality of times based on different control parameter setting information.

In addition, the servo adjustment system 1 according to the present embodiment preferably further includes a control target model virtualizing an industrial machine, and the servo adjustment device 10 is configured to acquire virtual FB information by driving the control target model 40 by the servo motor model 30 virtually controlled by the virtual control device 20.

According to the present embodiment, the servo adjustment can thereby be automatically performed based on the virtual FB information from the virtual environment 50 using the servo motor model 30 including the operation and characteristics of the servo motor and the control target model 40 including the operation and characteristics of the industrial machine, and the parameter setting can be automatically determined with high accuracy. Therefore, it is possible to generate virtual FB information more similar to the case of operating an actual machine, and thus servo adjustment more similar to the case of operating the actual machine is possible. In addition, compared with a case of the user deciding the parameter setting, the burden on the user can be reduced, and operational error can be prevented.

Furthermore, according to the present embodiment, since servo adjustment using the virtual environment 50 is possible, servo adjustment can be automatically performed in a short time by high-speed execution in the virtual environment 50. Therefore, it is possible to reduce downtime of equipment due to an actual machine not being required, and servo adjustment work is possible at the design stage.

Furthermore, according to the present embodiment, by constructing the virtual environment 50 accurately reflecting the dimensions, friction, mechanical rigidity, and the like of an industrial machine, it is possible to simulate the movement of the tool tip point from the virtual FB information, that is, from the behavior of the servo motor model, and an additional device such as an acceleration sensor is not necessary.

In addition, according to the present embodiment, since the evaluation program is executed by the virtual control device 20 in order to generate the virtual FB information, it is possible to easily obtain the virtual FB information for different command information, by changing the evaluation program. In addition, an actual machining program (or a part thereof) used by the user for machining can also be used as an evaluation program, and it is not necessary to separately prepare axis operation for evaluation, and an operation for which it is desired to actual adjust can be easily obtained.

### Second Embodiment

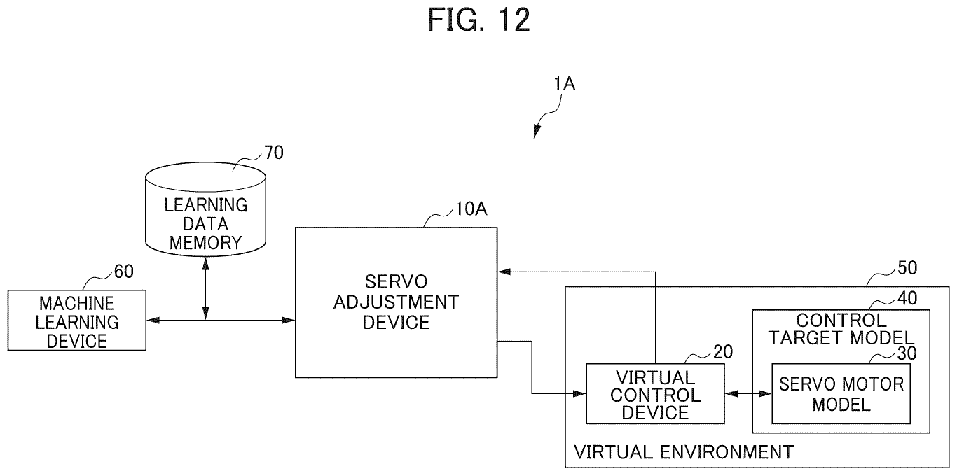

FIG. 12 is a block diagram illustrating a configuration of a servo adjustment system 1A according to a second embodiment. As shown in FIG. 12, the servo adjustment system 1A according to the second embodiment is different from the servo adjustment system 1 according to the first embodiment in the point of including a machine learning device 60 and a learning data memory 70, and other configurations thereof are shared with the first embodiment.

Similar to the servo adjustment device 10A and the virtual control device 20, the machine learning device 60 is a computer configured by hardware such as an arithmetic processing means such as a CPU, an auxiliary storage means such as an HDD or an SSD storing various computer programs, a main storage means such as RAM for storing data which is temporarily required upon the arithmetic processing means executing the computer programs, an operation means such as a keyboard on which an operator performs various operations, and a display means such as a display for displaying various kinds of information to an operator. The machine learning device 60 and the learning data memory 70 can transmit and receive various signals to and from the servo adjustment device 10A and the virtual control device 20, and the communication method thereof is not particularly limited.

The machine learning device 60 acquires virtual FB information from the virtual environment 50 via the servo adjustment device 10A, and executes servo adjustment by machine learning based on the acquired virtual FB information. That is, in the first embodiment, the servo adjustment device 10 is a configuration which determines the control parameter setting information according to a predetermined rule on the basis of the virtual FB information obtained based on a plurality of different parameter settings; whereas, in the present embodiment, the control parameter setting information is determined by machine learning using the machine learning device 60.

The learning data memory 70 acquires and registers machine learning data including a learning results executed by this machine learning device 60. The learning results include, for example, a quality determination result according to the above-described error amount, which is a difference of the virtual FB information relative to the command information to the servo motor model. The learnings result will be described in detail later.

The machine learning data registered in the learning data memory 70 is shared between the virtual environment 50 and an actual environment including a servo motor, a machine tool, a numerical control device, etc., which are not illustrated. It is thereby possible to execute servo adjustment by machine learning more efficiently, and possible to realize servo adjustment with higher accuracy in a short time.

Herein, the machine learning executed by the machine learning device 60 is not particularly limited, and supervised learning, unsupervised learning, reinforcement learning, and the like can be exemplified thereas. Among them, for example, reinforcement learning similar to the reinforcement learning described in Japanese Unexamined Patent Application, Publication No. 2018-180764 can be preferably applied to the machine learning device 60 of the present embodiment.

More specifically, the machine learning device 60 is configured so as to perform reinforcement learning on parameters (for example, parameters aᵢ and bⱼ (i, j≥0)) of the control parameter setting information, which is the target of servo adjustment, for example. More specifically, the machine learning device 60 is configured so as to perform Q-learning in which the values of the parameters aᵢ and bⱼ, the virtual FB information acquired by the virtual control device 20 executing the evaluation program, the command information to the servo motor model 30, and the like are defined as the state s, and the adjustment of the parameters aᵢ and bⱼ related to the state s is defined as an action a. As is well known to those skilled in the art, in the Q learning, the action a having the highest value Q(s, a) is selected as an optimal action from among actions a that can be taken when a certain state s. Thus, the optimum control parameter setting information can be selected. Since more detailed contents are described in Japanese Unexamined Patent Application, Publication No. 2018-180764, a detailed description thereof will be omitted here.

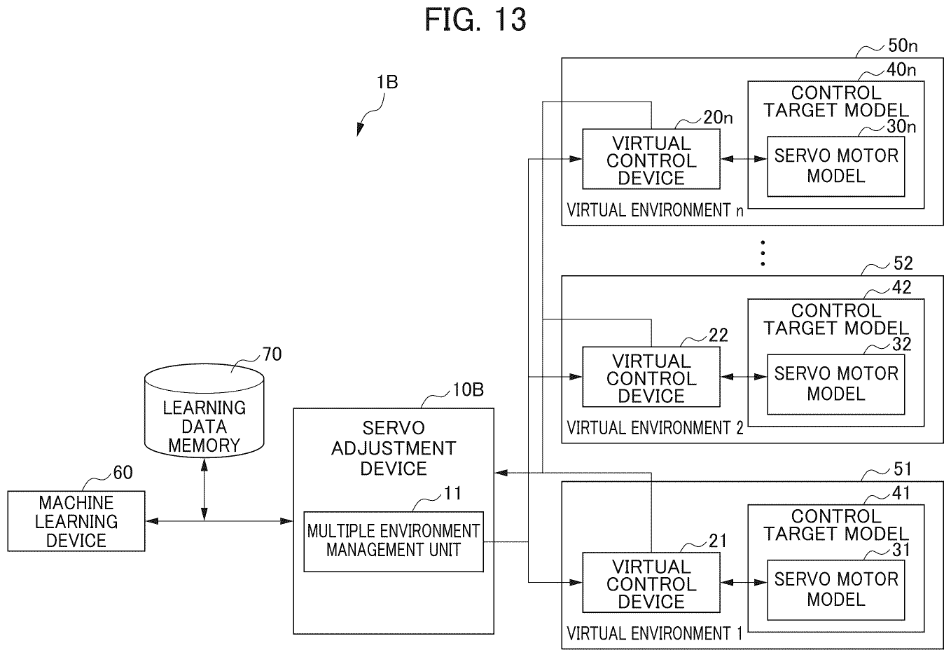

FIG. 13 is a block diagram illustrating the configuration of a servo adjustment system 1B according to a modification of the second embodiment. As shown in FIG. 13, the servo adjustment system 1B according to a modification of the second embodiment is different from the servo adjustment system 1A according to the second embodiment in the point of including a plurality of virtual environments 51, 52, . . . , 50n and a servo adjustment device 10B including a plurality of environment management units 11, and the other configurations thereof are shared with the second embodiment.

Each of the plurality of virtual environments 51, 52, . . . 50n has the same configuration as that of the virtual environment 50 of the first embodiment and the second embodiment. That is, each of the plurality of virtual environments 51, 52, . . . 50n has the same configuration. Therefore, in addition to the virtual control devices 21, 22, . . . 20n all having the same configuration, the servo motor models 31, 32, . . . 30n all have the same configuration, and the control target models 41, 42, . . . 40n all have the same configuration. Therefore, by virtually operating the model of the same machine tool and the servo motor model in a plurality of virtual environments, it is possible to acquire the virtual FB information in parallel, and it is possible to perform machine learning in parallel, and thus high-speed learning becomes possible.

The multiple environment management unit 11 included in the servo adjustment device 10B manages control parameter setting information to be applied to the plurality of virtual environments 51, 52, . . . , 50n. More specifically, the multiple environment management unit 11 manages parameter settings to be transmitted to the plurality of virtual environments 51, 52, . . . , 50n. That is, the multiple environment management unit 11 manages which parameter or which parameter setting pattern to be described later is executed in which virtual environment.

As a result, it becomes possible to execute the evaluation program with different parameter settings in each of the virtual environments 51, 52, . . . 50n, and acquire the virtual FB information. In addition, by collecting virtual FB information from a plurality of virtual environments 51, 52, . . . 50n as learning data and performing machine learning at the same time, then registering the obtained learning result in the learning data memory 70, and sharing the learning result among the plurality of virtual environments 51, 52, . . . 50n, it is thereby possible to perform higher-speed machine learning.

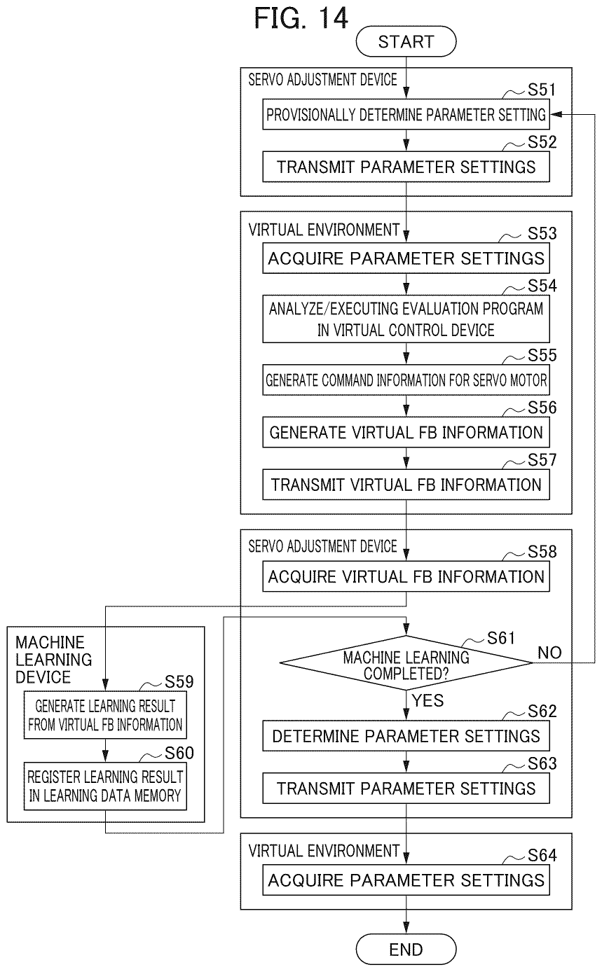

Next, the servo adjustment processing executed by the servo adjustment system 1A according to the second embodiment will be described in detail with reference to FIG. 14. Herein, FIG. 14 is a flowchart showing a sequence of servo adjustment processing executed by the servo adjustment system 1A according to the second embodiment. Execution of this servo adjustment processing is started in response to, for example, an input operation from the user on the servo adjustment device 10A. The servo adjustment processing executed by the servo adjustment system 1B according to the modification of the second embodiment is also the same as the sequence shown in FIG. 14.

In Step S51, the servo adjustment device 10A temporarily determines the parameter setting. Thereafter, the processing advances to Step S52. The temporary determination processing of the parameter setting will be described later in detail.

In Step S52, the servo adjustment device 10A transmits the parameter setting provisionally determined in the aforementioned Step S51 to the virtual control device 20 in the virtual environment 50. Thereafter, the processing advances to Step S53.

In Step S53, the virtual control device 20 acquires the parameter setting provisionally determined and transmitted by the servo adjustment device 10A. Thereafter, the processing advances to Step S54.

Steps S54 to S58 respectively correspond to Steps S11 to S15 of the servo adjustment processing according to the first embodiment, and the same processing is executed. That is, in the present embodiment, the virtual FB information is generated by analyzing and executing the evaluation program in the virtual control device 20, based on the parameter setting provisionally determined in the servo adjustment device 10A. Thereafter, the processing advances to Step S59.

In Step S59, the machine learning device 60 performs machine learning on the basis of virtual FB information based on a plurality of different pieces of control parameter setting information transmitted and acquired from the servo adjustment device 10A, and generates a learning result. Thereafter, the processing advances to Step S60.

In Step S60, the learning data memory 70 acquires the learning result obtained by machine learning by the machine learning device 60, and registers the acquired learning result in the data memory. Thereafter, the processing advances to Step S61.

In Step S61, the servo adjustment device 10A determines whether or not the machine learning by the machine learning device 60 has completed. If this determination is YES, the processing advances to Step S62, and if NO, the processing returns to Step S51.

In Step S62, the servo adjustment device 10A determines the parameter setting. Thereafter, the processing advances to Step S63. It should be noted that the parameter setting determination processing will be described in detail later.

Steps S63 and S64 respectively correspond to Steps S17 and S18 of the servo adjustment processing according to the first embodiment, and the same processing is executed. After the execution of Step S64, the present processing is ended.

Next, the temporary determination processing of the parameter setting in the above-described Step S51 will be described in detail with reference to FIG. 15. Herein, FIG. 15 is a flowchart showing a sequence of provisional determination processing of parameter setting.

In Step S71, the servo adjustment device 10A generates the setting pattern of the target parameter only for the first time. More specifically, one or more parameters serving as targets for obtaining an optimum value by machine learning by the machine learning device 60, that is, parameters (adjustment parameters) which are the target of servo adjustment, are determined, and a setting pattern of parameters for executing an evaluation program is generated. Thereafter, the processing advances to Step S72.

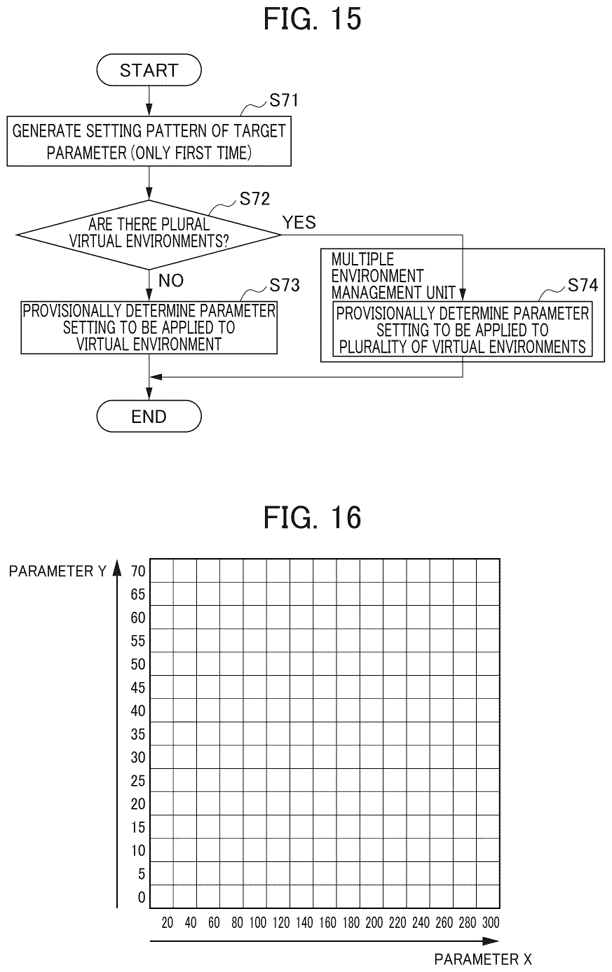

FIG. 16 is a diagram illustrating an example of a parameter setting pattern. As shown in FIG. 16, for example, a two-dimensional setting pattern is generated by defining a minimum value, a maximum value, and a step value for each of the two parameters X and Y. The parameter setting pattern shown in FIG. 16 is an example, and is not limited to a two-dimensional setting pattern, and may be a three-dimensional setting pattern. It should be noted that this setting pattern is automatically determined by the servo adjustment device 10A. However, it may be configured so that the user can determine the parameter setting pattern.

Referring back to FIG. 15, in Step S72, the servo adjustment device 10A determines whether there are a plurality of virtual environments. In the servo adjustment system 1A according to the second embodiment, since the virtual environment is one of the virtual environments 50, and thus this determination is NO, the processing advances to Step S73. On the other hand, in the servo adjustment system 1B according to the modification of the second embodiment, since there are a plurality of virtual environments such as the virtual environments 51, 52, . . . , 50n, and thus this determination is YES, the processing advances to Step S74.

In Step S73, due to being a case having only one virtual environment as in the second embodiment, the servo adjustment device 10A provisionally determines the parameter setting to be applied to the virtual environment 50, based on the parameter setting pattern shown in FIG. 16, for example, and the present processing is ended.

In Step S74, due to being a case having a plurality of virtual environments as in the modification of the second embodiment, the multiple environment management unit 11 included in the servo adjustment device 10B provisionally determines parameter settings to be applied to each of the plurality of virtual environments 51, 52, . . . , 50n based on the parameter setting pattern shown in FIG. 16, for example, and the present processing is ended.

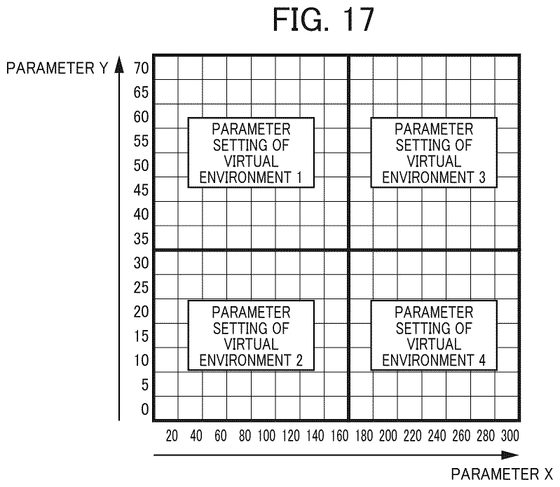

FIG. 17 is a diagram illustrating an example of parameter settings applied to a plurality of virtual environments. In the parameter setting shown in FIG. 17, a two-dimensional parameter setting pattern composed of the parameters X and Y shown in FIG. 16 is divided into four parts, and applied to each of the virtual environments 1 to 4. Since the servo adjustment system 1B according to the modification of the second embodiment has n number of virtual environments, the two-dimensional parameter setting pattern composed of the parameters X and Y shown in FIG. 16 may be divided into n number of parts, and applied to each of the virtual environments 51, 52, . . . 50n. Alternatively, when the number of target parameters is large, it may be configured to acquire the virtual FB information by distributing completely different patterns in each virtual environment such as the parameters X and Y in the virtual environment 51 and the parameters N and M in the virtual environment 52, and machine learn.

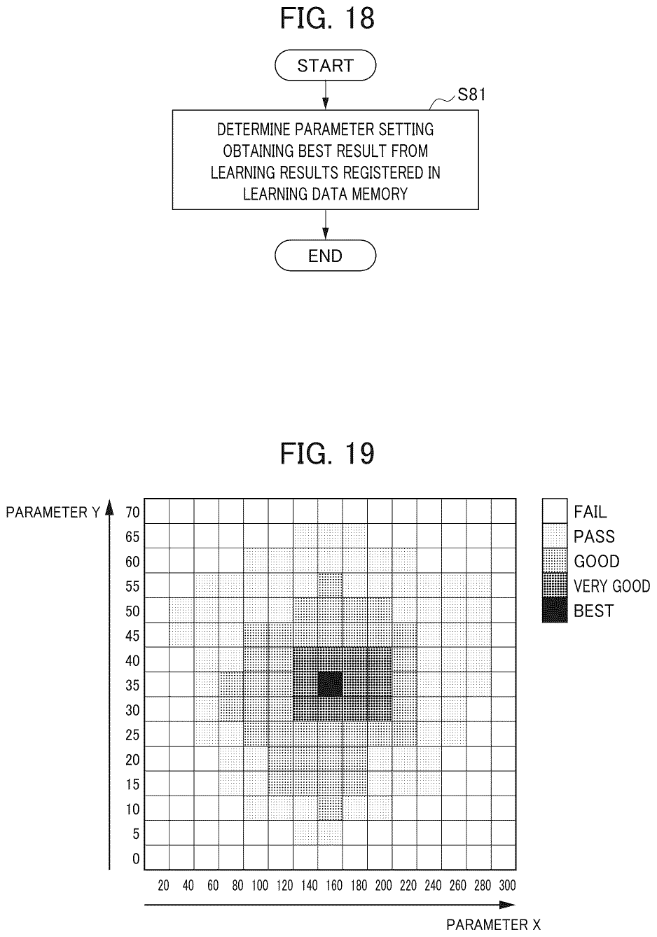

Next, the parameter setting determination processing in Step S62 will be described in detail with reference to FIG. 18. Here, FIG. 18 is a flowchart showing a sequence of parameter setting determination processing.

In Step S81, the servo adjustment device 10A determines a parameter setting for which the best determination result is obtained, from the learning results registered in the learning data memory 70. As a criterion of the determination, for example, a quality determination result according to an error amount which is a difference of the virtual FB information relative to the command information to the servo motor model can be exemplified. Thereafter, the present processing is ended.

Herein, FIG. 19 is a diagram illustrating an example of learning results. As shown in FIG. 19, specific quality determination results include, for example, determination results such as “best”, “very good”, “good”, “pass”, and “fail” in ascending order of error amount for each parameter setting. In the example shown in FIG. 19, since the best determination result is obtained for the parameter setting in which the parameter X is 160 and the parameter Y is 35, the servo adjustment device 10A determines as this parameter setting.

It should be noted that, in the actual operation, the optimum values determined in the virtual environment do not necessarily completely match in the actual environment. Therefore, for example, it is preferable to perform the machine learning again in the actual environment by limiting to the range determined as “best” or “very good”.

According to the servo adjustment systems 1A and 1B of the present embodiment, the following effects are exerted.

The servo adjustment system 1A according to the present embodiment further includes a machine learning device 60 that performs machine learning on the control parameter setting information using the virtual FB information, and the servo adjustment device 10A is configured to determine the control parameter setting information based on the learning result from the machine learning device 60.

Accordingly, the servo adjustment using the machine learning by the machine learning device 60 can be executed based on the virtual FB information obtained by the virtual control of the servo motor model 30 in the virtual environment 50. Therefore, according to the present embodiment, servo adjustment can be automatically performed with higher accuracy in a short time.

The servo adjustment system 1B according to the present embodiment is configured to include a plurality of virtual environments 51, 52, . . . , 50n having the virtual control devices 21, 22, . . . , 20n, the servo motor models 31, 32, . . . , 30n, and the control target models 41, 42, . . . , 40n. In addition, the servo adjustment device 10B includes the multiple environment management unit 11 that manages the control parameter setting information applied to the plurality of virtual environments 51, 52, . . . , 50n, and the machine learning device 60 is configured to machine learn the control parameter setting information using the virtual FB information obtained from the plurality of virtual environments 51, 52, . . . , 50n.

As a result, the control target models 41, 42, . . . 40n and the servo motor models 31, 32, . . . 30n are simultaneously and virtually operated in parallel in the plurality of virtual environments 51, 52, . . . 50n, so that the virtual FB information can be simultaneously acquired in parallel. Therefore, according to the present embodiment, machine learning based on the virtual FB information can be executed at a higher speed, and further, the servo adjustment can be automatically executed with high accuracy and in a short time.

It should be noted that the present disclosure is not limited to the above-described embodiments, and modifications and improvements within a scope that can achieve the object of the present disclosure are included in the present disclosure.

For example, in the above embodiment, a machine tool has been described as an example of the industrial machine; however, the present invention is not limited thereto. The present disclosure is also applicable to other industrial machines such as robots equipped with servo motors.

For example, in the above embodiment, the virtual environment 50 is configured to include the control target model 40; however, it is not limited thereto. The present disclosure is also applicable even to a virtual environment that does not include the control target model 40.

Further, for example, in the modification of the second embodiment, each of the virtual environments 51, 52, . . . 50n is configured to have the servo motor models 31, 32, . . . 30n and the control target models 41, 42, . . . 40n. This is not to be limiting. At least one of the plurality of virtual environments may be configured to include the servo motor model or the control target model, and the other virtual environments may not be configured to include the servo motor model or the control target model.

### EXPLANATION OF REFERENCE NUMERALS

1, 1A, 1B servo adjustment system
10, 10A, 10B servo adjustment device
11 multiple environment management unit
20, 21, 22, 20n virtual control device
30, 31, 32, 30n servo motor model
40, 41, 42, 40n control target model
50, 51, 52, 50n virtual environment
60 machine learning device
70 learning data memory

1. A servo adjustment system for adjusting control parameter setting information of a servo motor controlled by a control device of an industrial machine, the servo adjustment system comprising:
a servo motor model in which operation of the servo motor is virtualized;
a virtual control device which virtually controls the servo motor model by executing an evaluation program based on the control parameter setting information; and
a servo adjustment device which determines the control parameter setting information, based on virtual feedback information obtained by executing the evaluation program a plurality of times based on different pieces of the control parameter setting information in the virtual control device.

2. The servo adjustment system according to claim 1, further comprising a control target model in which the industrial machine is virtualized,
wherein the servo adjustment device acquires the virtual feedback information by causing the servo motor model virtually controlled by the virtual control device to run the control target model.

3. The servo adjustment system according to claim 1, further comprising a machine learning device which performs machine learning on the control parameter setting information using the virtual feedback information,
wherein the servo adjustment device determines the control parameter setting information based on a learning result from the machine learning device.

4. The servo adjustment system according to claim 3, comprising a plurality of virtual environments each having the virtual control device, and at least one of the servo motor models,
wherein the servo adjustment device includes a multiple environment management unit which manages the control parameter setting information to be applied to the plurality of the virtual environments, and
wherein the machine learning device performs machine learning on the control parameter setting information using the virtual feedback information obtained from the plurality of the virtual environments.

5. The servo adjustment system according to claim 2, further comprising a machine learning device which performs machine learning on the control parameter setting information using the virtual feedback information,
wherein the servo adjustment device determines the control parameter setting information based on a learning result from the machine learning device.

6. The servo adjustment system according to claim 5, comprising a plurality of virtual environments each having the virtual control device, and at least one of the servo motor models,
wherein the servo adjustment device includes a multiple environment management unit which manages the control parameter setting information to be applied to the plurality of the virtual environments, and
wherein the machine learning device performs machine learning on the control parameter setting information using the virtual feedback information obtained from the plurality of the virtual environments.
